(19) United States
(12) Patent Application Publication
(10) Pub. No.: US 2025/0059864 A1
(43) Pub. Date: Feb. 20, 2025

(54) METHODS AND SYSTEMS FOR MACHINE LEARNING BASED DRILLING FLUID TREATMENT RESPONSE PREDICTION

(71) Applicant: ARAMCO SERVICES COMPANY, Houston, TX (US)

(72) Inventors: Lei Fu, Houston, TX (US); Weichang Li, Houston, TX (US); Abdulaziz N. Almutairi, Dhahran (SA)

(73) Assignees: ARAMCO SERVICES COMPANY, Houston, TX (US); SAUDI ARABIAN OIL COMPANY, Dhahran (SA)

(21) Appl. No.: 18/450,108

(22) Filed: Aug. 15, 2023

(51) Int. Cl. E21B 43/25

(52) U.S. Cl. CPC E21B 43/255

(57) ABSTRACT

A method for determining drilling fluid properties. The method includes obtaining current drilling fluid properties for a drilling fluid used in a drilling operation, obtaining operational parameters related to the drilling operation, and obtaining a treatment, wherein the treatment describes one or more additives or processes to be applied the drilling fluid. The method further includes processing the current drilling fluid properties, the operational parameters, and the treatment with a treatment prediction system to determine a prediction for drilling fluid properties after treatment. The method further includes applying the treatment to the drilling fluid and using the drilling fluid, after application of the treatment, in the drilling operation.

### BACKGROUND

In the context of oil and gas industry, a drilling fluid is often used while drilling a wellbore. Generally, a drilling fluid is any fluid that is circulated in the borehole of a well to aid a drilling operation. For example, a drilling fluid may carry rock cuttings from a wellbore back to the surface. Drilling fluid may also be used to lubricate and cool a drill bit. Further, the drilling fluid, by hydrostatic pressure, may also assist in preventing the collapse of unstable strata into the wellbore as well as the intrusion of water from stratigraphic formations proximate the wellbore.

Drilling fluids are commonly classified as oil-based mud (OBM), water-based mud (WBM), brine-based fluid, or synthetic-based fluid. For any categorization, drilling fluids may be characterized by a variety of properties such as density, rheological properties, gels strengths, and electrical stability. Drilling is enhanced by tailoring and maintaining drilling fluid properties within a specified range based on the drilling requirements and subsurface formation. Typically, a drilling fluid is pumped into a wellbore and returns to the surface to be re-pumped into the wellbore forming a closed-loop circulation system. As such, the properties of a drilling fluid are continuously evolving while drilling due to interaction with the wellbore and the surrounding environment (e.g., subterranean formations, formation brine, etc.). Further, operational parameters controlling the drilling process (e.g., rate of penetration) may affect the properties of a drilling fluid. To maintain desired drilling fluid properties and to modify the properties of a drilling fluid according to changes in the subsurface while drilling, a chemical treatment must be applied to the drilling fluid.

Conventionally, treatment decisions are made by a drilling fluids specialist (DFS) based on measured properties of the circulated drilling fluid. Because treatment decisions rely on the expertise of individual drilling fluid specialists, treatments are not consistently applied often leading to issues of over- or undertreatment. Accordingly, there exists a need to automatically determine, without relying on the expertise of a DFS, the effect of a treatment applied to a drilling fluid.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method for determining drilling fluid properties. The method includes obtaining current drilling fluid properties for a drilling fluid used in a drilling operation, obtaining operational parameters related to the drilling operation, and obtaining a treatment, wherein the treatment describes one or more additives or processes to be applied the drilling fluid. The method further includes processing the current drilling fluid properties, the operational parameters, and the treatment with a treatment prediction system to determine a prediction for drilling fluid properties after treatment. The method further includes applying the treatment to the drilling fluid and using the drilling fluid, after application of the treatment, in the drilling operation.

Embodiments disclosed herein generally relate to a non-transitory computer-readable memory comprising computer-executable instructions stored thereon that, when executed on a processor, cause the processor to perform the following steps. The steps include obtaining current drilling fluid properties for a drilling fluid used in a drilling operation, obtaining operational parameters related to the drilling operation, and obtaining a treatment, wherein the treatment describes one or more additives or processes to be applied the drilling fluid. The steps further include processing the current drilling fluid properties, the operational parameters, and the treatment with a treatment prediction system to determine a prediction for drilling fluid properties after treatment, where, upon application of the treatment to the drilling fluid, the drilling fluid is used in the drilling operation.

Embodiments disclosed herein generally relate to a system for determining drilling fluid properties. The system includes a drilling system conducting a drilling operation where the drilling system includes a drilling fluid. The drilling system is configured to drill a wellbore through a subsurface. The system further includes a computer configured to: obtain current drilling fluid properties for the drilling fluid used in the drilling system; obtain operational parameters related to the drilling operation; obtain a treatment, wherein the treatment describes one or more additives or processes to be applied the drilling fluid; and process the current drilling fluid properties, the operational parameters, and the treatment with a treatment prediction system to determine a prediction for drilling fluid properties after treatment. Further, upon application of the treatment to the drilling fluid using the system, the drilling fluid is used in the drilling operation.

Other aspects and advantages of the claimed subject matter will be apparent from the following description and the appended claims.

### BRIEF DESCRIPTION OF DRAWINGS

FIG. 1 depicts a drilling fluid processing system, in accordance with one or more embodiments.

FIG. 2 depicts a drilling system in accordance with one or more embodiments.

FIG. 3A depicts a system in accordance with one or more embodiments.

FIG. 3B depicts a system in accordance with one or more embodiments.

FIG. 4 depicts a system in accordance with one or more embodiments.

FIG. 5 depicts a flowchart in accordance with one or more embodiments.

FIG. 6 depicts a neural network in accordance with one or more embodiments.

FIG. 7 depicts a flowchart, in accordance with one or more embodiments.

FIG. 8 depicts the flow of data through a treatment prediction system in accordance with one or more embodiments.

FIG. 9 depicts a flowchart in accordance with one or more embodiments.

FIG. 10 depicts a system in accordance with one or more embodiments.

### DETAILED DESCRIPTION

In general, embodiments of the disclosure include systems and methods for determining the effect of a treatment applied to a drilling fluid, also called drilling mud (or, more simply, mud). Further, one or more embodiments relate to systems and methods for determining a treatment for a drilling fluid in order to achieve a desired set of drilling fluid properties. The methods and systems may further include an automated drilling fluid mixing process using real-time sensors and control systems. For example, various drilling fluid property values may be adapted by automatically deploying a treatment, where the treatment is determined by the methods and systems disclosed herein. In one or more embodiments, sensor data is collected at different stages of a drilling fluid mixing process, the sensor data is analyzed to determine a treatment, and the treatment is applied to the drilling fluid.

Thus, an automated mixing process may adjust a total drilling fluid volume and drilling fluid properties by adding fresh drilling fluid and additives throughout a continuous drilling operation. In some embodiments, for example, monitored drilling fluids properties may include rheological behavior, pH levels, and/or density values, such as specific gravity values, etc. The drilling fluid, with continuously monitored and updated drilling fluid properties may be circulated through a drill string into the wellbore. Thus, automating a drilling fluid mixing process and the determination of a desired treatment may increase efficiency in drilling fluid production, increase drilling fluid quality, and/or reduce losses of net productive time (NPT).

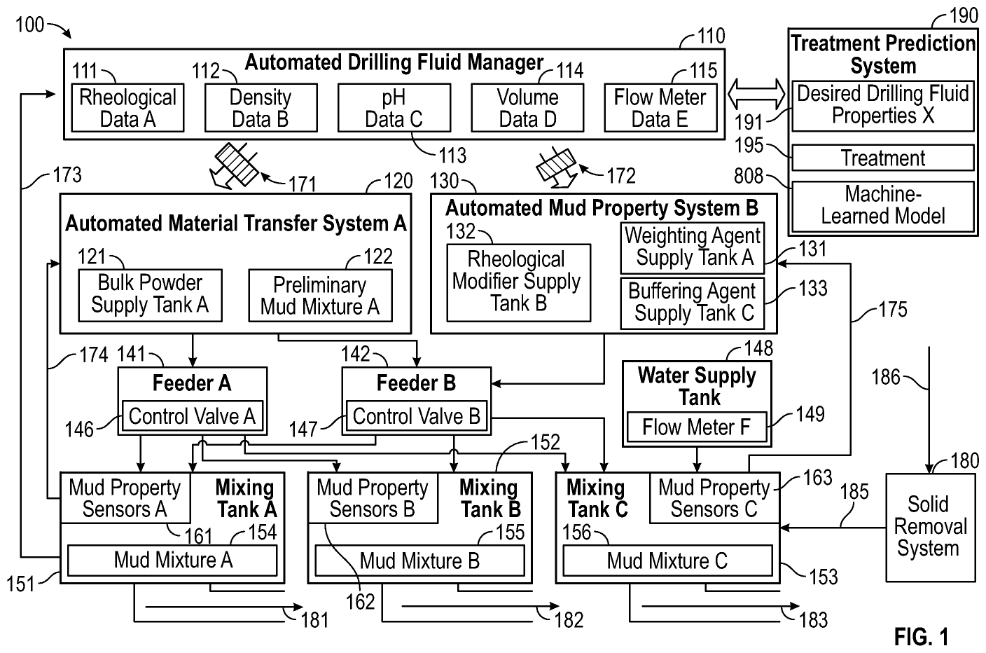

Turning to FIG. 1, FIG. 1 shows a schematic diagram in accordance with one or more embodiments. FIG. 1 illustrates a drilling fluid processing system (100) that may include an automated drilling fluid manager (e.g., automated drilling fluid manager (110)) coupled to a treatment prediction system (e.g., treatment prediction system (190)), various feeders (e.g., feeder A (141), feeder B (142)), various control valves (e.g., control valve A (146), control valve B (147)), various mixing tanks (e.g., mixing tank A (151), mixing tank B (152), mixing tank C (153)), and a solid removal system (e.g., solid removal system (180)). An automated drilling fluid manager may include hardware and/or software that includes functionality for monitoring and/or controlling various chemical components used within the drilling fluid processing system (100). In some embodiments, for example, the automated drilling fluid manager transmits one or more commands (e.g., command X (171), command Y (172)) to various control systems (e.g., automated material transfer system A (120), automated mud property system B (130)) in order to produce drilling fluids (e.g., drilling fluid A (181), drilling fluid B (182), drilling fluid C (183)) having specific drilling fluid properties (e.g., drilling fluid properties X (191)). Commands may include data messages transmitted over one or more network protocols using a network interface, such as through wireless data packets. Likewise, a command may also be a control signal, such as an analog electrical signal, that triggers one or more operations in a particular control system (e.g., automated mud property system B (130)) and/or a drilling fluid processing component (e.g., control valve A (146)).

Furthermore, drilling fluid properties may correspond to different physical qualities associated with drilling fluid, such as specific gravity values, viscosity levels, pH levels, rheological values such as flow rates, temperature values, resistivity values, mud mixture weights, mud particle sizes, and various other attributes that affect the role of drilling fluid in a wellbore. For example, a drilling fluid property may be selected by a user to have a desired predetermined value, which may include a range of acceptable values, a specific threshold value that should be exceeded, a precise scalar quantity, etc. As such, an automated drilling fluid manager or another control system may obtain sensor data (e.g., sensor data A (173), sensor data B (174), sensor data C (175)) from various drilling fluid property sensors (e.g., mud property sensors A (161), mud property sensors B (162), mud property sensors C (163)) regarding various drilling property parameters. Examples of drilling fluid property sensors include pH sensors, density sensors, rheological sensors, volume sensors, weight sensors, flow meters, etc. Likewise, sensor data may refer to both raw sensor measurements and/or processed sensor data associated with one or more drilling fluid properties (e.g., rheological data A (111), density data B (112), pH data C (113), volume data D (114), flow meter data E (115)).

In some embodiments, an automated drilling fluid manager includes functionality for managing one or more mixing stages of a drilling fluid (e.g., mud mixture A (154), mud mixture B (155), mud mixture C (156)) within a mixing tank (e.g., mixing tank A (151), mixing tank B (152), mixing tank C (153)). Furthermore, within this disclosure, “mud mixture” may refer to a mixture input or a mixture output of one or more mixing stages of a drilling fluid production process, while “drilling fluid” may refer to a final output of the drilling fluid production process that is sent to a wellbore. However, “mud mixture” and “drilling fluid” are not intended to have discrete meanings, and may be interchangeable at times, e.g., a “drilling fluid processing system” may manage “mud mixtures” at different stages of a “drilling fluid production process.”

With respect to a mixing tank, a mixing tank may be a container or other type of receptacle (e.g., a mud pit) for mixing various liquids, fresh mud, recycled mud, additives, and/or other chemicals to produce a particular mud mixture. For example, a mixing tank may be coupled to one or more mud supply tanks, one or more additive supply tanks, one or more dry/wet feeders (e.g., feeder A (141), feeder B (142)), and one or more control valves for managing the mixing of chemicals within a respective mixing tank. Control valves may be used to meter chemical inputs into a mixing tank, as well as release drilling fluid into a mixing tank. Likewise, a mixing tank may include and/or be coupled to various types of drilling fluid equipment not shown in FIG. 1, such as various mud pumps, mud lines, liquid supply lines, and/or other mixing equipment.

In some embodiments, the drilling fluid processing system (100) includes an automated material transfer system (e.g., automated material transfer system A (120)). In particular, an automated material transfer system may be a control system with functionality for managing supplies of bulk powder and other inputs for producing a preliminary mud mixture (e.g., preliminary mud mixture A (122)). For example, an automated material transfer system may include a pneumatic, conveyer belt or a screw-type transfer system (e.g., using a screw pump) that transports material from a supply tank upon a command from a sensor-mediated response. Once an automated drilling fluid manager actives an automated material transfer system, the automated material transfer system may monitor a mixing tank using weight sensors and/or volume sensors to meter a predetermined amount of bulk powder to a selected mixing tank. Likewise, the automated material transfer system may include hardware and/or software to provide water (e.g., using water supply tank (148)) to a mixing tank to produce a preliminary mud mixture. For example, water (or mineral oil or diesel in the case of oil-based muds) may be metered through a flow meter (e.g., flow meter F (149)) to a mixing tank. Once material for the preliminary mud mixture is transferred, the automated material transfer system may notify an automated drilling fluid manager that the task or mixing stage is complete. In some embodiments, for example, the preliminary mud mixture is a dry blended composition that has a predetermined accuracy with drilling fluid provided to a wellbore (e.g., drilling fluid properties that match 90-95% of a final mud mixture). For example, a preliminary mud mixture may be produced away from a wellsite and kept in a supply tank (e.g., bulk powder supply tank (121)) at the wellsite. Accordingly, an automated material transfer system may transfer additional amounts of materials from a supply tank upon command from a sensor-mediated response to fine-tune various drilling fluid properties.

Keeping with FIG. 1, once a preliminary mud mixture is disposed in a mixing tank, an automated drilling fluid manager may transmit one or more commands to activate an automated mud property system (e.g., automated mud property system B (130)) to control the supply of various additives to a mixing tank. In some embodiments, for example, an automated mud property system may include hardware and/or software with functionality for automatically supplying and/or mixing weighting agents (e.g., weighting agent supply tank A (131)), buffering agents (e.g., buffering agent supply tank C (133)), rheological modifiers (e.g., rheological modifier supply tank B (132)), and/or other additives until a mud mixture matches and/or satisfies one or more desired drilling fluid properties. Examples of weighting agents may include barite, hematite, calcium carbonate, siderite, etc. A buffering agent may be a pH buffering agent that causes a mud mixture to resist changes in pH levels. For example, a buffering agent may include water, a weak acid (or weak base) and salt of the weak acid (or a salt of weak base). Rheological modifiers may include drilling fluid additives that adjust one or more flow properties of a drilling fluid. One type of rheological modifier is a viscosifier, which may be an additive with functionality for providing thermal stability, hole-cleaning, shear-thinning, improving carrying capacity as well as modifying other attributes of a drilling fluid. Examples of viscosifiers include bentonite, inorganic viscosifiers, polymeric viscosifiers, low-temperature viscosifiers, high-temperature viscosifiers, oil-fluid liquid viscosifiers, organophilic clay viscosifiers, and biopolymer viscosifiers.

Furthermore, the automated mud property system and/or the automated drilling fluid manager may monitor various drilling fluid properties in real-time using one or more mud property sensors. In some embodiments, the treatment prediction system (190) receives sensor data from one or more mud property sensors and determines the effect of a treatment (195). Herein, a treatment (195) is described as set of prescribed additives, and their amounts, and processes to be applied to a drilling fluid. For example, a treatment may specify the amount and type of viscosifier and weighting agent to be injected and/or mixed into a supply of recycled drilling fluid (185). In one or more embodiments, the treatment prediction system (190) includes user-specified desired drilling fluid properties (e.g., desired drilling fluid properties X (191)). In one or more embodiments, the treatment prediction system (190) determines the properties of a drilling fluid given an initial state of the drilling fluid and the application a specified treatment (195). In such cases, the predicted drilling properties may be compared to the desired drilling fluid properties to determine if the treatment should be applied. In other embodiments, the treatment prediction system (190) determines the treatment (195) that should be applied to a given drilling fluid, based on the current properties of the drilling fluid, in order to achieve the desired drilling fluid properties. For example, an automated drilling fluid manager may be coupled to the treatment prediction system (190) through a user interface provided by the automated drilling fluid manager or remotely over a network (e.g., a remote connection through Internet access or a wireless connection at a well site). Based on real-time updates received for a current mud mixture, the automated drilling fluid manager may implement a prescribed treatment where the treatment or effect of the treatment is determined by the treatment prediction system (190) (e.g., in response to changes in drilling operations in the wellbore).

The automated drilling fluid manager may include functionality for transmitting a command for causing drilling fluid to circulate through a drill string for continuous drilling, e.g., drilling fluid A (181), drilling fluid B (182), and drilling fluid C (183) shown in FIG. 1. Likewise, the drilling fluid processing system (100) may receive used drilling fluid from a wellbore (e.g. used drilling fluid X (186)) that is passed through a solid removal system (e.g., solid removal system (180)). More specifically, a solid removal system may include equipment and other hardware for removing particular solids, such as drill cuttings and coarse aggregates, from used drilling fluid in order to recycle drilling fluid (e.g., recycled drilling fluid (185)) into the drilling fluid processing system (100). Recycled drilling fluid may require fewer weighting agents, such as Barite, or mud additives for reprocessing prior to recirculation in a wellbore. Thus, an automated drilling fluid manager may also prepare recycled drilling fluid using an automated material transfer system and/or automated mud property system in a similar manner as performed for a fresh mud mixture.

Keeping with FIG. 1, an automated drilling fluid manager, an automated material transfer system, and/or an automated mud property system may include one or more control systems that include one or more programmable logic controllers (PLCs). Specifically, a programmable logic controller may control valve states, fluid levels, pipe pressures, warning alarms, and/or pressure releases throughout a drilling fluid processing system (100). In particular, a programmable logic controller may be a ruggedized computer system with functionality to withstand vibrations, extreme temperatures, wet conditions, and/or dusty conditions, for example, around a drilling rig. In some embodiments, the automated drilling fluid manager (110), the automated material transfer system A (120), the automated mud property system B (130), and/or the treatment prediction system (190) may include a computer system that is similar to the computer system described below with regard to FIG. 12 and the accompanying description.

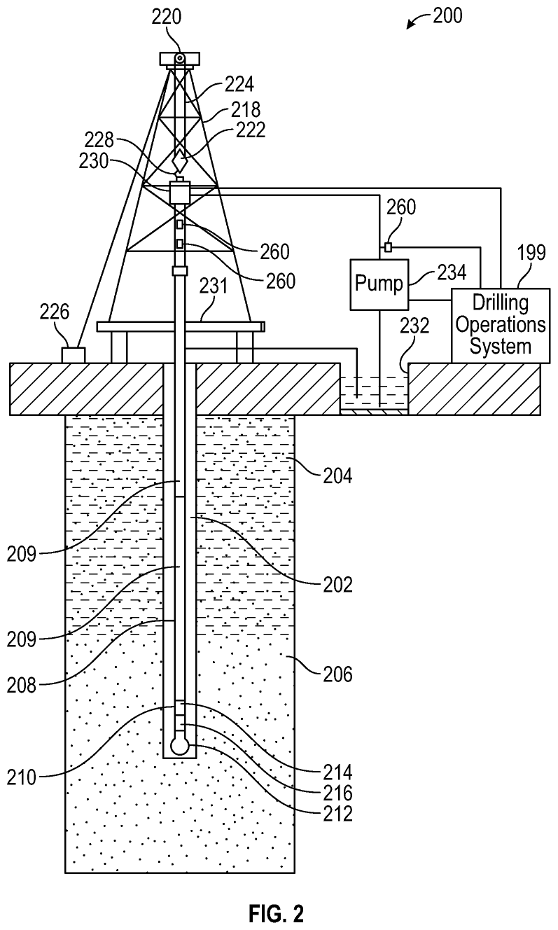

FIG. 2 illustrates an example well site (200). A well site (200) may be used to extract oil and gas, generally referred to as hydrocarbons, from underground reservoirs. In general, well sites may be configured in a myriad of ways. Therefore, well site (200) is not intended to be limiting with respect to the particular configuration of the drilling equipment. The well site (200) is depicted as being on land. In other examples, the well site (200) may be offshore, and drilling may be carried out with or without use of a marine riser. A drilling operation at well site (200) may include drilling a wellbore (202) into a subsurface including various formations (204, 206). For the purpose of drilling a new section of wellbore (202), a drill string (208) is suspended within the wellbore (202).

The drill string (208) may include one or more drill pipes (209) connected to form conduit and a bottom hole assembly (BHA) (210) disposed at the distal end of the conduit. The BHA (210) may include a drill bit (212) to cut into the subsurface rock. The BHA (210) may include measurement tools (214), such as a measurement-while-drilling (MWD) tool and logging-while-drilling (LWD) tool. Measurement tools (214) may include sensors and hardware to measure downhole drilling parameters, and these measurements may be transmitted to the surface using any suitable telemetry system known in the art. The BHA (210) and the drill string (208) may include other drilling tools known in the art but not specifically shown.

The drill string (208) may be suspended in wellbore (202) by a derrick (218). A crown block (220) may be mounted at the top of the derrick (218), and a traveling block (222) may hang down from the crown block (220) by means of a cable or drilling line (224). One end of the cable (224) may be connected to a drawworks (226), which is a reeling device that may be used to adjust the length of the cable (224) so that the traveling block (222) may move up or down the derrick (218). The traveling block (222) may include a hook (228) on which a top drive (230) is supported.

The top drive (230) is coupled to the top of the drill string (208) and is operable to rotate the drill string (208). Alternatively, the drill string (208) may be rotated by means of a rotary table (not shown) on the drilling floor (231). Drilling fluid (commonly called “mud”) may be stored in a mud pit (232), and at least one pump (234) may pump the mud from the mud pit (232) into the drill string (208). The mud may flow into the drill string (208) through appropriate flow paths in the top drive (230) (or a rotary swivel if a rotary table is used instead of a top drive to rotate the drill string (208)). Drilling fluid (or mud) is any fluid that is circulated in the wellbore (202) to aid in the drilling operation. Drilling fluids may be broadly categorized according to their principal constituent. For example, a drilling fluid may be said to be an oil-based mud (OBM), water-based mud (WBM), brine-based fluid, or synthetic-based fluid. The base component for a water-based drilling fluid (or WBM) may be fresh water, seawater, brine, saturated brine, or a formate brine. The liquid part of a drilling fluid is known as “mud filtrate.” When a drilling fluid passes through a porous medium (e.g., subsurface formation (204, 206)), solid particulates suspended in the drilling fluid may become separated from the mud filtrate. Solid particulates, upon separation, may accumulate and form a layer commonly known as “mudcake.” Some well sites (200) may include a drilling fluid processing system (100) like that of FIG. 1 (not shown in FIG. 2). The drilling fluid processing system (100) may include hardware and/or software with functionality for automatically supplying and/or mixing weighting agents, buffering agents, rheological modifiers, and/or other additives to the drilling fluid until it matches and/or satisfies one or more desired drilling fluid properties. In other words, the composition of a drilling fluid may be complex and a drilling fluid may be tailored to a specific well site (200), and, in some instances, the composition of a drilling fluid may be altered in real-time according to the needs of a drilling operation. As stated, in one or more embodiments, the drilling fluid processing system (100) may include or be communicatively coupled to a treatment prediction system (190) that specifies desired drilling fluid properties (e.g., desired drilling fluid properties X (191)). In one or more embodiments, the treatment prediction system (190) determines the properties of a drilling fluid given an initial state of the drilling fluid and the application a specified treatment (195). In other embodiments, the treatment prediction system (190) determines the treatment (195) that should be applied to a given drilling fluid, based on the current properties of the drilling fluid, in order to achieve the desired drilling fluid properties.

In some implementations, a drilling operations system (299) may be disposed at or communicate with the well site (200). Drilling operations system (299) may control at least a portion of a drilling operation at the well site (200) by providing controls to various components of the drilling operation. In one or more embodiments, drilling operations system (299) may receive data from one or more sensors (260) arranged to measure controllable parameters of the drilling operation. As a non-limiting example, sensors (260) may be arranged to measure: weight on bit (WOB), drill string rotational speed (e.g., rotations per minute (RPM)), flow rate of the mud pumps (e.g., in the units of gallons per minute (GPM)), and rate of penetration of the drilling operation (ROP). In one or more embodiments, the drilling operation may be controlled by the drilling operations system (299).

Sensors (260) may be positioned to measure parameter(s) related to the rotation of the drill string (208), parameter(s) related to travel of the traveling block (222), which may be used to determine ROP of the drilling operation, and parameter(s) related to flow rate of the pump (234). For illustration purposes, sensors (260) are shown on drill string (208) and proximate mud pump (234). The illustrated locations of sensors (260) are not intended to be limiting, and sensors (260) could be disposed wherever drilling parameters need to be measured. Moreover, there may be many more sensors (260) than shown in FIG. 2 to measure various other parameters of the drilling operation. Each sensor (260) may be configured to measure a desired physical stimulus.

During a drilling operation at the well site (200), the drill string (208) is rotated relative to the wellbore (202), and weight is applied to the drill bit (212) to enable the drill bit (212) to break rock as the drill string (208) is rotated. In some cases, the drill bit (212) may be rotated independently with a drilling motor. In some implementations, the drilling motor is a positive displacement motor (216) located on the distal end of the drill string (208) as part of the BHA (210). In further embodiments, the drill bit (212) may be rotated using a combination of the drilling motor, such as a positive displacement motor (216), and the top drive (230) (or a rotary swivel if a rotary table is used instead of a top drive to rotate the drill string (208)). While cutting rock with the drill bit (212), mud is pumped into the drill string (208).

The drilling fluid flows down the drill string (208) and exits into the bottom of the wellbore (202) through nozzles in the drill bit (212). The drilling fluid in the wellbore (202) then flows back up to the surface in an annular space between the drill string (208) and the wellbore (202) with entrained cuttings.

The drilling fluid with the cuttings is returned to the pit (232) to be circulated back again into the drill string (208). Typically, the cuttings are removed from the drilling, and the drilling fluid is reconditioned as necessary, before pumping the drilling fluid again into the drill string (208).

Depending on the depth of hydrocarbon bearing formation and other geological complexes, a well can have several hole sizes before it reaches its target depth. A steel pipe, or casing (not shown), may be lowered in each hole and a cement slurry may be pumped from the bottom up through the presumably annular space between the casing and the wellbore (202) to fix the casing, seal the wellbore from the surrounding subsurface (204, 206) formations, and ensure proper well integrity throughout the lifecycle of the well. The casing may be inserted periodically while drilling out the well.

Upon finishing drilling the wellbore (202), the well may undergo a “completions” process to stabilize the well and provide reliable access to the desired hydrocarbons. In some implementations, the final wellbore (202) can be completed using either cased and cemented pipe, which is later perforated to access the hydrocarbon, or it may be completed using a multi-stage open-hole packers assembly. Once completed, a well site (200) may be used in production to extract hydrocarbons from underground reservoirs.

In one aspect, embodiments disclosed herein relate to a treatment prediction system (190). The treatment prediction system may include user-specified desired drilling fluid properties (e.g., desired drilling fluid properties X (191)) and a treatment (195). In one or more embodiments, the treatment prediction system (190) automatically determines, without relying on the expertise of a DFS, the effect of a treatment applied to a drilling fluid given the treatment and the initial state, or determined properties, of the drilling fluid. In one or more embodiments, the treatment prediction system (190) prescribes a treatment to achieve a set of desired drilling fluid properties given the initial state, or determined properties, of the drilling fluid.

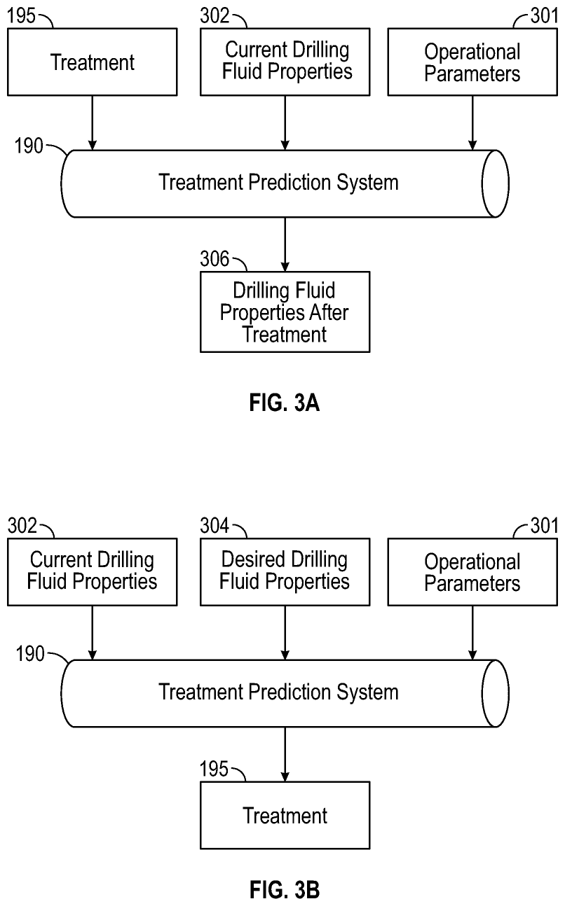

FIG. 3A depicts a high-level overview of the use of the treatment prediction system (190) in accordance with one or more embodiments. As seen in FIG. 3A, in one or more embodiments, the treatment prediction system (190) receives the current properties of a drilling fluid (e.g., current drilling fluid properties (302)), a treatment (195), and one or more operational parameters (301) describing the drilling operations and/or drilling fluid processes. The current drilling fluid properties (302) may be obtained by one or more sensors disposed on an automated drilling fluid manager (110) as sensor data. The sensor data may include rheological data (e.g., rheological data A (111)), density data (e.g., density data B (112)), pH data (e.g., pH data C (113)), volume data (e.g., volume data D (114)), and flow meter data (e.g., flow meter data E (115)). The current drilling fluid properties (302) may also be obtained through periodic sampling and testing of the drilling fluid. For example, in one or more embodiments, various standardized tests are performed on samples of the drilling fluid in order to determine one or more drilling fluid properties. In general, the measured properties may include, but are not limited to, the properties listed in Table I alongside a brief description of each property.

TABLE I
Drilling fluid properties and accompanying description.

| Property | Description |
|---|---|
| 10 second gel strength | A measure of shear stress supported by the drilling fluid |
| | after the drilling fluid is allowed to set for 10 seconds. |
| | Generally, gel strength is a measure of the inter-particle |
| | forces that prevent cuttings from settling in the borehole. |
| 10 minute gel strength | A measure of shear stress supported by the drilling fluid |
| | after the drilling fluid is allowed to set for 10 minutes. |
| | Generally, gel strength is a measure of the inter-particle |
| | forces that prevent cuttings from settling in the borehole. |
| 30 minute gel strength | A measure of shear stress supported by the drilling fluid |
| | after the drilling fluid is allowed to set for 30 minutes. |
| | Generally, gel strength is a measure of the inter-particle |
| | forces that prevent cuttings from settling in the borehole. |
| Electrical stability | A measure of the maximum voltage (electrical potential) |
| (E-stability or ES) | that can be sustained in the drilling fluid before establishing |
| | an electrical current. The ES number can describe the |
| | emulsion and wetting quality of the drilling fluid. |
| HTHP Fluid Loss | A measure of drilling fluid filtration into the surrounding |
| | formation under a static condition over a period of time. |
| | Further measure the filter-cake building capability of the |
| | drilling fluid. |
| Low Gravity Solid (LGS) | Low gravity solids is a type of drilling mud solid having a |
| Percent | lower density than the barite or hematite that is used to |
| | weight up a drilling fluid. Thus, LGS percent indicates the |
| | percentage of low gravity solids present in the drilling fluid. |
| Low-shear Yield Point | A measure of the drilling fluid's vulnerability to barite sage. |
| (LSYP) | |
| Plastic Viscosity (PV) | A measure of the viscosity, or shear stress normalized by |
| | shear rate, of the drilling fluid. |
| Yield Point (YP) | A measure of the resistance of a fluid to flow when at rest. |
| | Generally, a measure of the attractive force among colloidal |
| | particles in the drilling fluid. |
| Fluid Weight | The density of the drilling fluid. |
| Oil Ratio | A ratio of the percent oil to percent water in the drilling fluid |
| | (typically, percentages are taken by volume). |

Keeping with FIG. 3A, the treatment prediction system (190) also receives operational parameters (195). The operational parameter may consist of one or more parameters that describe the drilling operation including processes involving the drilling fluid. Some operational parameters may be directly measured while others are derived from measured quantities. Operational parameters may change as drilling progresses. As such, operational parameters may be measured and/or calculated periodically. In one or more embodiments, operational parameters are determined in real time. Herein, when operational parameters are used by the treatment prediction system (190), it is understood that the operational parameters will represent the current, or most current, state of the drilling operation. Some example operational parameters, and their description, are provided in Table II.

TABLE II
Example operational parameters and accompanying descriptions.

| Operational Parameter | Description |
|---|---|
| True Vertical Depth | Depth into the wellbore measured vertically from the |
| (TVD) | surface. |
| Starting Volume | Original mud weight required to yield a predetermined final |
| | volume of desired mud weight. |
| Calculated End Volume | The ending fluid volume calculated by the starting and |
| | added volume. |
| Drilled Hole Volume | The volume of the wellbore. |
| Water Volume Added | Total water added to the fluid. |
| Sum | |
| Loss Volume | Volume of drilling fluid that does not return from the |
| | wellbore during circulation. That is, the volume of drilling |
| | fluid entering subsurface formations. |

Keeping with FIG. 3A, the treatment prediction system (190) also receives a treatment (195). Herein, a treatment (195) is set of additives (and their quantities) and/or processes that may be applied to the drilling fluid. In some instances, the addition of an additive may itself be considered a treatment. As such, a treatment (195) may consist of one or more treatments or chemical treatments. Some example treatments, and their description, are provided in Table III.

TABLE III
Example treatments, and accompanying descriptions, that
may be used as a treatment (195) for a drilling fluid.

| Additive or Process | Description |
|---|---|
| Calcium Chloride Powder | Used to provide calcium ions in drilling fluids which |
| | help in maintaining the alkalinity, reduce fluid loss and |
| | increase the density of the mud. |
| Diesel | Used as an oil phase/base fluid in OBM. |
| Graphite Plugging Agent | Used to seal permeable formations and decrease fluid |
| | loss. It can withstand high temperatures and is |
| | chemically inert. |
| Fine Graphite | A plugging agent, its smaller particle size can help seal |
| | micro-fractures in the formation. |
| Polymeric Viscosifier | A polymer used to increase the viscosity of the drilling |
| | fluid, which aids in carrying cuttings to the surface and |
| | stabilizing the borehole. |
| Hubercarb M200 (meduium) | A type of ground calcium carbonate that can be used to |
| | control fluid loss and regulate pH. |
| LIME | Used to control pH and alkalinity in the drilling fluid and |
| | helps with fluid loss control. |
| Barite | A heavyweight additive used to increase the density of |
| | drilling fluids, helping to maintain well control by |
| | counteracting the pressure in the formation. |
| Fibrous plugging and | Fibrous materials are used to bridge and seal permeable |
| binding agent | formations reducing the fluid loss. |
| Emulsifier | Used to stabilize the emulsion of the oil and water phase |
| | in the drilling fluid. |
| Mica | Used as a lost circulation material to prevent the drilling |
| | fluid from being lost to the formation. |
| Pecan Nut | Used as a plugging agent to prevent fluid loss. |
| Premium Clay Viscosifier | A high-quality clay used to increase the viscosity of the |
| | drilling fluid, which aids in suspending cuttings and |
| | maintaining borehole stability. |

As seen in FIG. 3A, upon receiving a treatment (195), the operational parameters (301), and the current drilling fluid properties (302), the treatment prediction system (190) determines what the properties of the current drilling fluid will be after receiving the treatment (e.g., drilling fluid properties after treatment (306)). In other words, in one or more embodiments, the treatment prediction system (306) determines the properties of a drilling fluid upon receiving a prescribed treatment given the initial properties (or state or condition) of the drilling fluid and any relevant operational parameters.

FIG. 3B depicts a high-level overview of the use of the treatment prediction system (190) in accordance with one or more embodiments. As seen in FIG. 3B, in one or more embodiments, the treatment prediction system (190) receives the current properties of a drilling fluid (e.g., current drilling fluid properties (302)), the operational parameters (301), and the desired drilling fluid properties (304) (e.g., desired drilling fluid properties X (191)). The current drilling fluid properties (302) may be obtained by one or more sensors disposed on an automated drilling fluid manager (110) as sensor data. The sensor data may include rheological data (e.g., rheological data A (111)), density data (e.g., density data B (112)), pH data (e.g., pH data C (113)), volume data (e.g., volume data D (114)), and flow meter data (e.g., flow meter data E (115)). The current drilling fluid properties (302) may also be obtained through periodic sampling and testing of the drilling fluid. For example, in one or more embodiments, various standardized tests are performed on samples of the drilling fluid in order to determine one or more drilling fluid properties. In general, the measured properties may include, but are not limited to, the properties listed in Table I.

The desired drilling fluid properties (304) indicate the desired properties of the drilling fluid as specified by a user or drilling fluid specialist (DFS) according to the determined needs of the drilling operation in view of the subsurface. For example, drilling may be optimized (e.g., reduction in drilling time to reach a target depth) by supplying a drilling fluid tailored to the specific circumstances of the drilling operation. As seen in FIG. 3B, upon receiving the desired drilling fluid properties (304), the operational parameters (301), and the current drilling fluid properties (302), the treatment prediction system (190) determines the treatment (195) that should be applied to the current drilling fluid in order to alter and align its properties with the desired drilling fluid properties (304). In other words, in one or more embodiments, the treatment prediction system (306) prescribes a treatment (195) to obtain a set of desired drilling fluid properties given the initial properties (or state or condition) of the drilling fluid and any relevant operational parameters (301).

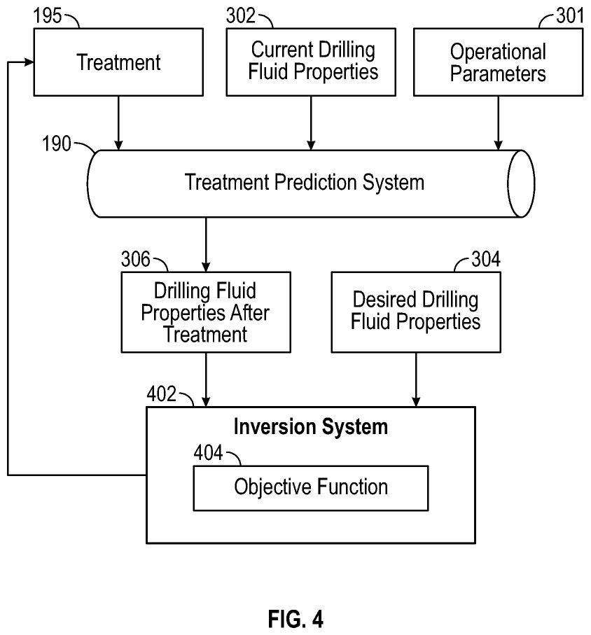

In one or more embodiments, the treatment prediction system (190) depicted in FIG. 3A is coupled with an inversion system (402) to determine the treatment (195), that once applied to a drilling fluid characterized by a set of current drilling fluid properties (302), will result in a drilling fluid with properties that align with a set of desired drilling fluid properties (304). An overview of the treatment prediction system (190) used with an inversion system (402) is depicted in FIG. 4.

As depicted in FIG. 4, and similar to FIG. 3A, the treatment prediction system (190) receives a specified treatment (195), operational parameters (301), and the current drilling fluid properties (302) of a drilling fluid and predicts the properties that the drilling fluid would have after application of the treatment (306). It is noted that, typically, at this stage the treatment (195) is not actually applied to the drilling fluid, only that the treatment prediction system (190) predicts the properties that the drilling fluid will have if the drilling fluid receives the specified treatment (195) given the current properties of the drilling fluid and operational parameters (301). In general, the inversion system (402) performs a comparison of the predicted drilling fluid properties after treatment (306) and a set of desired drilling fluid properties (304). In one or more embodiments, the comparison is performed using an objective function (404), where the objective function (404) quantifies the difference between the predicted drilling fluid properties after treatment (306) and the given set of desired drilling fluid properties (304). The inversion system (402) determines the treatment (195) that results in the best congruence of the predicted drilling fluid properties after treatment (306) and the given set of desired drilling fluid properties (304), where the congruency is quantified by the objective function (404). In one or more embodiments, the inversion system (402) uses an iterative process where, in each iteration, the inversion system (402) outputs an update to the treatment (195) and re-processes the treatment (195) with the treatment prediction system (190), along with the current drilling fluid properties (302), until triggering a termination criterion. The termination criterion may include, but is not limited to: exceeding a pre-defined number of iterations, diminishing changes or updates to the treatment (195), and the objective function (404) achieving a pre-defined threshold.

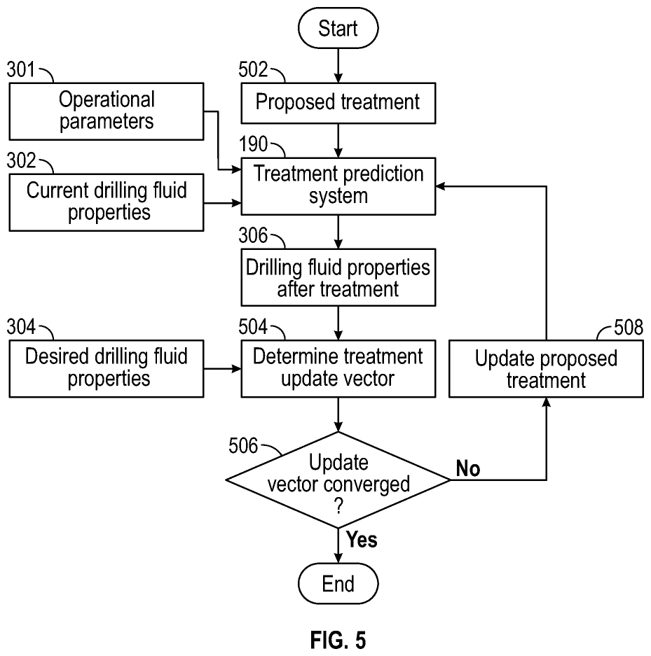

FIG. 5 depicts a high-level overview of an iterative inversion process (e.g., that may be employed by the inversion system (402)), in accordance with one or more embodiments. To begin, as depicted in Block 502, an initial or proposed treatment is supplied. In the context of the instant disclosure, the proposed treatment may specify the quantity of various chemical additives that may be injected or mixed into a drilling fluid. In one or more embodiments, the proposed treatment is represented as a vector, where each element indicates either the application of a process or the quantity of an additive to be added and is initialized (i.e., given initial values) by a DFS. As seen in FIG. 5, the proposed treatment (Block 502) is processed by the treatment prediction system (Block 190) along with the current drilling fluid properties (Block 302) and operational parameters (Block 301) to predict the properties of the drilling fluid after treatment (Block 306).

Continuing with FIG. 5, in Block 504, an update to the proposed treatment is determined. In one or more embodiments, when the proposed treatment is represented as a vector, a treatment update vector is determined. The treatment update vector represents a change that should be applied to the proposed treatment vector. The update is determined, in part, by comparing the drilling fluid properties after treatment (prediction in Block 306) to the desired drilling fluid properties (Block 304). The comparison is performed using an objective function (404). In one or more embodiments, additional functions are included in the objective function (404). These additional functions may serve to regularize the objective function and/or provide physics-based constraints on the proposed treatment. For example, when considering chemical additives, negative quantity values may not be appropriate. In Block 506, a check is performed to determine if the update to the proposed treatment is substantial. If the update to the proposed treatment is not considered substantial, then application of the treatment update to the proposed treatment would not significantly alter the proposed treatment. In such a case, the proposed treatment is said to be converged. Thus, if according to Block 506, the proposed treatment is converged, the inversion process ends. If, however, the proposed treatment is not converged, the treatment update is applied to the proposed treatment in Block 508.

Upon updating, the proposed treatment is considered a new proposed treatment. After Block 508, the inversion process returns to Block 190 such that the new proposed treatment may be processed anew by the treatment prediction system which produces a new prediction for the drilling fluid properties after treatment. The new prediction for the drilling fluid properties after treatment is compared to the desired drilling fluid properties to determine a new treatment update in Block 504. If the new treatment update is significant (i.e., not converged), the new proposed treatment is updated (in Block 508) resulting in another new proposed treatment. Without undue ambiguity, the new proposed treatment (and subsequent updates to new proposed treatment) can simply be referred to as the proposed treatment. That is, in FIG. 5, after receiving a first, or original, proposed treatment, the proposed treatment is updated iteratively until the proposed treatment does not significantly change between iterations. For example, consider the case where the proposed treatment is represented mathematically by a vector m. Using this notation, a treatment update to the proposed treatment is represented as δm. In accordance with one or more embodiments, in Block 504, the proposed treatment vector is considered converged if |δm|<ϵ, where the operator |·| represents the L₁ norm (“Manhattan” norm) and ϵ is a pre-defined threshold value.

In accordance with one or more embodiments, the objective function (404) is given as

$$ϕ ( m : {d}_{desired} , {m}_{p} , {d}_{current} ) = {ϕ}_{d} ( m : {d}_{desired} , {d}_{current} ) + {λ}_{1} {ϕ}_{m} ( m : {m}_{p} ) + {λ}_{2} {ϕ}_{q} ( m ) ,$$

where ϕ_{d} is a measure of the data misfit (i.e., quantification of the difference between the desired drilling fluid properties (represented a vector d_{desired}) and the predicted drilling fluid properties after treatment), ϕₘ is a model regularization term, ϕ_{q} is a penalty term to enforce any desired physical constraints on the proposed treatment, and λᵢ, i=1, . . . 2 are different Lagrange multipliers. The data misfit function Od, intuitively, makes use of the desired drilling fluid properties, d_{desired}, and the current drilling fluid properties, d_{current}, where the current drilling fluid properties are processed with the proposed treatment m to generate the predicted drilling fluid properties after treatment. The model regularization function ϕₘ, in addition to the proposed treatment vector, depends on a prior proposed treatment vector mₚ (i.e., prior, or expected values for the proposed treatment). The prior proposed treatment vector includes any prior information known about the proposed treatment. In one or more embodiments, the prior prosed treatment vector is the same as the initial, or original, proposed treatment vector. In one or more embodiments, the inversion system (402) uses a genetic algorithm.

Currently, a chemical and/or physics-based model for drilling fluid treatment and response prediction is not possible due to the complexity of the composition of drilling fluids and interactions with respect to the effects on drilling fluid properties between individual treatments (e.g., chemical additives). As such, in accordance with one or more embodiments, the treatment prediction system (190) includes a machine-learned model.

Machine learning (ML), broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning (ML), or machine-learned, will be adopted herein, however, one skilled in the art will recognize that the concepts and methods detailed hereafter are not limited by this choice of nomenclature.

Machine-learned model types may include, but are not limited to, k-means, k-nearest neighbors, neural networks, logistic regression, random forests, generalized linear models, and Bayesian regression. Also, machine-learning encompasses model types that may further be categorized as “supervised”, “unsupervised”, “semi-supervised”, or “reinforcement” models. One with ordinary skill in the art will appreciate that additional or alternate machine-learned model categorizations may be defined without departing form the scope of this disclosure. Machine-learned model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a model is referred to as selecting the model “architecture.”

A cursory introduction to a few machine-learned models and the general principles related to training a supervised machine-learned model are provided below. However, while descriptions of machine-learned models are provided to aid in understanding, one with ordinary skill in in the art will recognize that these descriptions do not impose a limitation on the instant disclosure. This is because one with ordinary skill in the art will appreciate that, due to the depth and breadth of the field, a detailed description of the field of machine learning, and the various model types encompassed by the field, cannot be adequately summarized in the present disclosure.

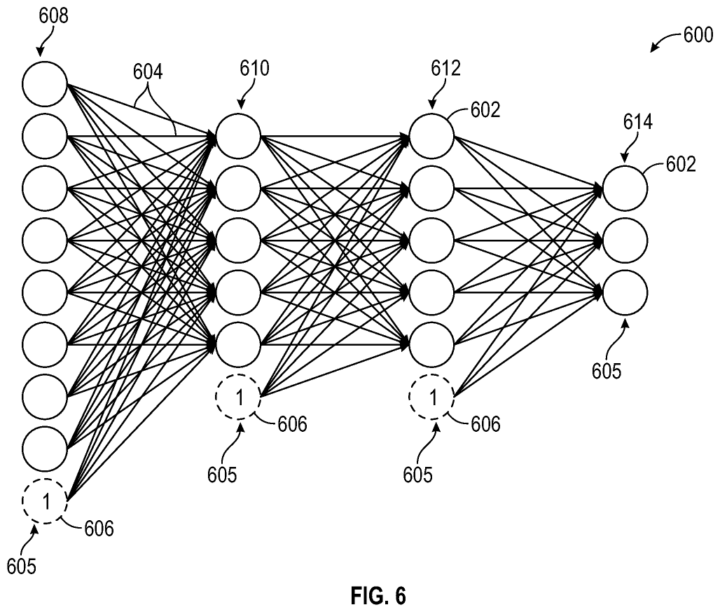

A commonly employed type of machine-learned model is a neural network (NN). A diagram of a neural network is shown in FIG. 6. At a high level, a neural network (600) may be graphically depicted as being composed of nodes (602), where here any circle represents a node, and edges (604), shown here as directed lines. The nodes (602) may be grouped to form layers (605). FIG. 6 displays four layers (608, 610, 612, 614) of nodes (602) where the nodes (602) are grouped into columns, however, the grouping need not be as shown in FIG. 6. The edges (604) connect the nodes (602). Edges (604) may connect, or not connect, to any node(s) (602) regardless of which layer (605) the node(s) (602) is in. That is, the nodes (602) may be sparsely and residually connected. A neural network (600) will have at least two layers (605), where the first layer (608) is considered the “input layer” and the last layer (614) is the “output layer.” Any intermediate layer (610, 612) is usually described as a “hidden layer”. A neural network (600) may have zero or more hidden layers (610, 612) and a neural network (600) with at least one hidden layer (610, 612) may be described as a “deep” neural network or as a “deep learning method.” In general, a neural network (600) may have more than one node (602) in the output layer (614). In this case the neural network (600) may be referred to as a “multi-target” or “multi-output” network.

Nodes (602) and edges (604) carry additional associations. Namely, every edge is associated with a numerical value. The edge numerical values, or even the edges (604) themselves, are often referred to as “weights” or “parameters.” While training a neural network (600), numerical values are assigned to each edge (604). Additionally, every node (602) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) ,$$

where i is an index that spans the set of “incoming” nodes (602) and edges (604) and ƒ is a user-defined function. Incoming nodes (602) are those that, when viewed as a graph (as in FIG. 6), have directed arrows that point to the node (602) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (602) in a neural network (600) may have a different associated activation function. Often, as a shorthand, activation functions are described by the function ƒ by which it is composed. That is, an activation function composed of a linear function ƒ may simply be referred to as a linear activation function without undue ambiguity.

When the neural network (600) receives an input, the input is propagated through the network according to the activation functions and incoming node (602) values and edge (604) values to compute a value for each node (602). That is, the numerical value for each node (602) may change for each received input. Occasionally, nodes (602) are assigned fixed numerical values, such as the value of 1, that are not affected by the input or altered according to edge (604) values and activation functions. Fixed nodes (602) are often referred to as “biases” or “bias nodes” (606), displayed in FIG. 6 with a dashed circle.

In some implementations, the neural network (600) may contain specialized layers (605), such as a normalization layer, or additional connection procedures, like concatenation. One skilled in the art will appreciate that these alterations do not exceed the scope of this disclosure.

As noted, the training procedure for the neural network (600) comprises assigning values to the edges (604). To begin training the edges (604) are assigned initial values. These values may be assigned randomly, assigned according to a prescribed distribution, assigned manually, or by some other assignment mechanism. Once edge (604) values have been initialized, the neural network (600) may act as a function, such that it may receive inputs and produce an output. As such, at least one input is propagated through the neural network (600) to produce an output. Training data is provided to the neural network (600). Generally, training data consists of pairs of inputs and associated targets. The targets represent the “ground truth”, or the otherwise desired output, upon processing the inputs. During training, the neural network (600) processes at least one input from the training data and produces at least one output. Each neural network (600) output is compared to its associated input data target. The comparison of the neural network (600) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (600) output and the associated target. The loss function may also be constructed to impose additional constraints on the values assumed by the edges (604), for example, by adding a penalty term, which may be physics-based, or a regularization term. Generally, the goal of a training procedure is to alter the edge (604) values to promote similarity between the neural network (600) output and associated target over the training data. Thus, the loss function is used to guide changes made to the edge (604) values, typically through a process called “backpropagation”.

While a full review of the backpropagation process exceeds the scope of this disclosure, a brief summary is provided. Backpropagation consists of computing the gradient of the loss function over the edge (604) values. The gradient indicates the direction of change in the edge (604) values that results in the greatest change to the loss function. Because the gradient is local to the current edge (604) values, the edge (604) values are typically updated by a “step” in the direction indicated by the gradient. The step size is often referred to as the “learning rate” and need not remain fixed during the training process. Additionally, the step size and direction may be informed by previously seen edge (604) values or previously computed gradients. Such methods for determining the step direction are usually referred to as “momentum” based methods.

Once the edge (604) values have been updated, or altered from their initial values, through a backpropagation step, the neural network (600) will likely produce different outputs. Thus, the procedure of propagating at least one input through the neural network (600), comparing the neural network (600) output with the associated target with a loss function, computing the gradient of the loss function with respect to the edge (604) values, and updating the edge (604) values with a step guided by the gradient, is repeated until a termination criterion is reached. Common termination criteria are: reaching a fixed number of edge (604) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (604) values are no longer intended to be altered, the neural network (600) is said to be “trained.”

In accordance with one or more embodiments, to develop a machine-learned model for the treatment prediction system (190), many combinations of machine-learned model types and hyperparameters are developed and tested. As seen in the example of a neural network (NN), a supervised machine-learned model must be trained using a set of training data, where the set of training data consists of pairs of inputs and associated targets. In accordance with one or more embodiments, a set of training data is collected from historical data and includes the measured properties of a drilling fluid before and after a given treatment as well as the operational parameters at the time the treatment was applied. Thus, the set of training data includes past examples of treatments applied to drilling fluids and the effect of the treatment. In one or more embodiments, the past examples of treatments, operational parameters, and drilling fluid properties are collected over a diverse set of drilling operations (e.g., different geographic regions with varying lithologies) to promote robustness and generalization performance of the machine-learned model. In one or more embodiments, the set of training data is structured such that the drilling fluid properties before treatment, the operational parameters, and the treatment are considered as the inputs and the drilling fluid properties after treatment are considered as the target (See FIG. 3A). In one or more embodiments, the set of training data is structured such that the drilling fluid properties before treatment, the operational parameters, and the drilling fluid properties after treatment are considered as the inputs and the treatment is considered as the target (See FIG. 3B). In this case, while the drilling fluid properties after treatment may not be considered “desired” drilling fluid properties, the machine-learned model may be trained to determine the treatment that alters the properties of the drilling fluid from the drilling fluid properties before treatment to the drilling fluid properties after treatment.

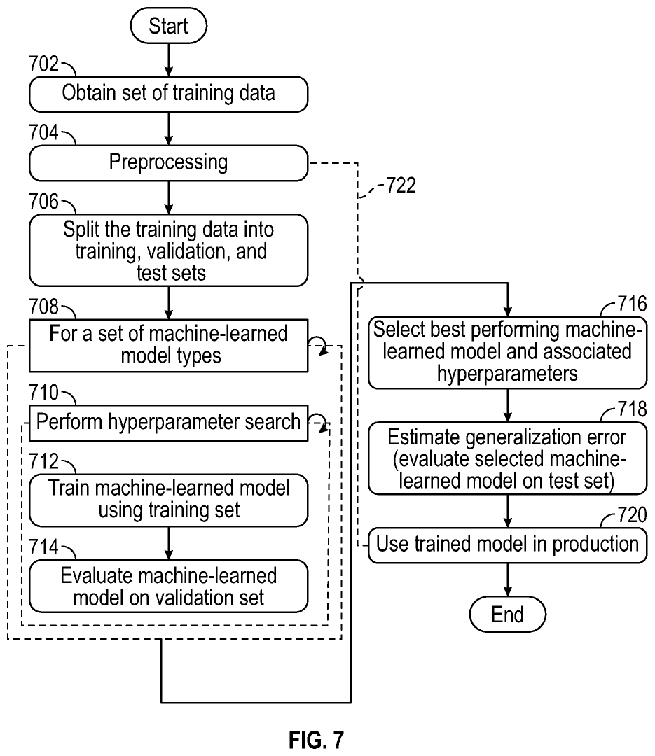

In accordance with one or more embodiments, the general process for developing and using a machine-learned model for use in the treatment prediction system (190) is depicted in the flowchart of FIG. 7. As shown in Block 702, the process starts by obtaining a set of training data. In one or more embodiments, the set of training data consists of thousands of instances where a treatment was applied to a drilling fluid and knowledge of the properties of the drilling fluid before and after treatment, as well as knowledge of the treatment itself and the operational parameter at the time of its application, are available.

In one or more embodiments, the set of training data may be preprocessed as shown in Block 704. Preprocessing, at a minimum, comprises altering the data so that it is suitable for use with machine-learned models. For example, numericalizing categorical data or removing data entries with missing values. Other typical preprocessing methods are normalization and imputation. Normalization is the process of transforming, or scaling, values of the set of training data with an intention to aid the machine-learned model. Imputation is the process of replacing missing values, corrupted values, or outlier values in a set of data with a substitute value so that the data may be used in a machine-learned model. One imputation strategy may be to replace values with the nearest acceptable value in the data set. In one or more embodiments, preprocessing requires the determination of one or more preprocessing parameters (e.g., the mean and standard deviation of a drilling fluid property over the set of training data). In general, information surrounding the preprocessing steps is saved as preprocessing parameters for potential later use. This allows future data instances to be preprocessed identically to those in the set of training data.

One with ordinary skill in the art with recognize that a myriad of preprocessing methods beyond numericalization, removal of modeling data entries with missing values, normalization, and imputation exist. Thus, the enumeration of a select few preprocessing methods herein do not impose a limitation on the preprocessing steps encompassed by this disclosure.

Keeping with FIG. 7, in Block 706, the set of training data is split into training, validation, and test sets. Thus, the nomenclature of the instant disclosure allows for a “set of training data” to include a “training set,” a “validation set,” and a “test set.” In some embodiments, the validation and test set may be the same such that the set of training data is effectively only split into two distinct sets. In one or more embodiments, Block 706 may be implemented before Block 704. In these instances, generally any preprocessing parameters are determined using only the training set. Subsequently, the preprocessing steps are applied to the training set, validation set, and test set using the using the preprocessing parameters determined from the training set. A common splitting method is to randomly select a portion X of the data instances for the training set, a portion Y for the validation set, and assign the remaining portion of samples to the test set. For example, 80% of the data instances may be assigned to the training set, 10% to the validation set, and the remaining 10% to the testing set. However, one with ordinary skill in the art will recognize that other splitting methods and/or set proportions may be used without exceeding the scope of this disclosure.

Once the set of training data is split, the training set, validation set, and test set are used to train, tune, evaluate, and select a machine-learned model for use in the treatment prediction system (190). In accordance with one or more embodiments, to discover a high performing machine-learning model, one or more machine-learned model types and associated model hyperparameters are tested. To do so, a set of machine-learned model types may be defined, for example, a set may be defined to contain the model types: {logistic regression, k-nearest neighbors, gradient boosting, neural network}. Block 708 represents an iterator where each model type in the set of model types is processed according to the enclosed blocks. Likewise, Block 710 represents another iterator to cycle over hyperparameters associated with the model and perform the enclosed operations. In other words, in Block 708 a model type is selected, and in Block 710 associated hyperparameters are selected. The hyperparameters search may be performed using any method known in the art. As non-limiting examples, the hyperparameters search of Block 710 may be performed according to a grid search, a random search, or a Bayesian-based search.

For each model type and applied hyperparameters, the machine-learned model is trained using the training set, as shown in Block 712. Once a machine-learned model is trained, its performance is evaluated on the validation set, as depicted in Block 714. In the case where there is no validation set, such as when the set of training data is only split into training and testing sets, the testing set may be used for the validation set. In some embodiments, one or more validation sets may be temporarily extracted from the training set using methods like cross-validation (e.g., leave-one-out cross-validation, k-folds cross-validation). Evaluating the machine-learned model consists of processing data instances of the validation set with the trained machine-learned model to produce predictions (e.g., drilling fluid properties after treatment or treatment), and comparing the predictions with the associated targets. The evaluation of the validation set in Block 714 guides the hyperparameter search of Block 710. That is, for each model type, the best combination of hyperparameters is selected by comparing the performance of each model, with its associated hyperparameters, as evaluated on the validation set. As stated, in some embodiments, the hyperparameter search may be performed over data sets temporarily extracted from the training set through cross-validation techniques.

Through the iterators of Blocks 708 and 710, and the evaluations of Block 714, the best performing machine-learned model type, and associated hyperparameters, may be identified. In Block 716, this best performing machine-learned model is selected.

In Block 720, the selected machine-learned model is used in production. Using the selected machine-learned model in production consists of making the model readily accessible to be used with new data instances not included in the set of training data. That is, the selected machine-learned model may be used in (or as) the treatment prediction system (190) as depicted in either FIG. 3A or FIG. 3B.

However, before the machine-learned model is used in production a final indication of its performance can be acquired by estimating the generalization error of the selected machine-learned model, as shown in Block 718. The generalization error is estimated by evaluating the performance of the selected machine-learned model on the test set. One with ordinary skill in the art will recognize that the training procedure depicted in FIG. 7 is general and that many adaptions can be made without departing from the scope of the present disclosure. For example, common training techniques, such as early stopping, adaptive or scheduled learning rates, and cross-validation may be used during training without departing from the scope of this disclosure.

As previously stated, many machine-learned model types may be employed in treatment prediction system (190) depicted in FIGS. 3A and 3B. For example, machine-learned model types may include, but are not limited to, random forest, support vector machine, k-nearest neighbors, k-means, extra trees, and neural networks. In one or more embodiments, a single machine-learned model is trained and selected to make predictions on two or more target quantities (e.g., two or more drilling fluid properties after treatment). That is, the selected machine-learned model may be a multi-target machine-learned model. In other embodiments, the treatment prediction system (190) consists of an ensemble of machine-learned models, where each model makes a prediction on a single target quantity. That is, in one or more embodiments, multiple machine-learned models are trained (e.g., according to the procedure of FIG. 7) and each machine-learned model is trained for a specific task (e.g., prediction for a single drilling fluid property after treatment).

In one or more embodiments, the selected machine-learned model type is a gradient boosted trees regressor. Generally, a gradient boosted trees regressor is an ensemble of decision trees. A decision tree is composed of nodes. A decision is made at each node such that data present at the node are segmented. Typically, at each node, the data at said node, are split into two parts, or segmented bimodally, however, multimodal segmentation is possible. The segmented data can be considered another node and may be further segmented. As such, a decision tree represents a sequence of segmentation rules. The segmentation rule (or decision) at each node is determined by an evaluation process. The evaluation process usually involves calculating which segmentation scheme results in the greatest homogeneity or reduction in variance in the segmented data. However, a detailed description of this evaluation process, or other potential segmentation scheme selection methods, is omitted for brevity and does not limit the scope of the present disclosure.

Further, if at a node in a decision tree, the data are no longer to be segmented, that node is said to be a “leaf node.” Commonly, values of data found within a leaf node are aggregated, or further modeled, such as by a linear model. A decision tree can be configured in a variety of ways, such as, but not limited to, choosing the segmentation scheme evaluation process, limiting the number of segmentations, and limiting the number of leaf nodes. Generally, when the number of segmentations or leaf nodes in a decision tree is limited, the decision tree is said to be a “weak learner.”

In most implementations, the decision trees from which a gradient boosted trees regressor is composed are weak learners. Additionally, for a gradient boosted trees regressor, the decision trees are ensembled in series, wherein each decision tree makes a weighted adjustment to the output of the preceding decision trees in the series. The process of ensembling decision trees in series, and making weighted adjustments, to form a gradient boosted trees regressor is best illustrated by considering the training process of a gradient boosted trees regressor.

The following description of the gradient boosted trees training process assumes that properly formatted set of training data (after normalization, imputation, etc.), which contains both the data inputs and the desired output data (or target data, or “targets”), is supplied.

Training a gradient boosted trees regressor consists of the selection of segmentation rules for each node in each decision tree; that is, training each decision tree. Once trained, a decision tree is capable of processing data. For example, a decision tree may receive a data input. The data input is sequentially transferred to nodes within the decision tree according to the segmentation rules of the decision tree. Once the data input is transferred to a leaf node, the decision tree outputs the assigned value of the associated leaf node which is usually the average value of the target of all data instances assigned to the leaf node.

Generally, training a gradient boosted regressor firstly consists of making a simple prediction (SP) for the target data. The simple prediction (SP) may be the average value of the target data. The simple prediction (SP) is subtracted from the targets to form a first residuals. The first decision tree in the series is created and trained, wherein the first decision tree attempts to predict the first residuals forming first residual predictions. The first residual predictions from the first decision tree are scaled by a scaling parameter. In the context of gradient boosted trees the scaling parameter is known as the “learning rate” (η). The learning rate is one of the hyperparameters governing the behavior of the gradient boosted trees regressor. The learning rate (η) may be fixed for all decision trees or may be variable or adaptive. The first residual predictions of the first decision tree are multiplied by the learning rate (i) and added to the simple prediction (SP) to form a first predictions. The first predictions are subtracted from the targets to form a second residuals. A second decision tree is created and trained using the data inputs and the second residuals as targets such that it produces second residual predictions. The second residual predictions are multiplied by the learning rate (η) and are added to the first predictions forming second predictions. This process is repeated recursively until a termination criterion is achieved.

Many termination criteria exist and are not all enumerated here for brevity. Common termination criteria are terminating training when a pre-defined number of decision trees has been reached, or when improvement in the residuals is no longer observed.

Once trained, a gradient boosted trees regressor may make predictions using input data. To do so, the input data is passed to each decision tree, which will form a plurality of residual predictions. The plurality of residual predictions are multiplied by the learning rate (η), summed across every decision tree, and added to the simple prediction (SP) formed during training to produce the gradient boosted trees predictions.

One with ordinary skill in the art will appreciate that many adaptions may be made to gradient boosted trees and that these adaptions do not exceed the scope of this disclosure. Some adaptions may be algorithmic optimizations, efficient handling of sparse data, use of out-of-core computing, and parallelization for distributed computing. In accordance with one or more embodiments, the selected machine-learned model type is an adapted gradient boosted trees model known as XGBoost.

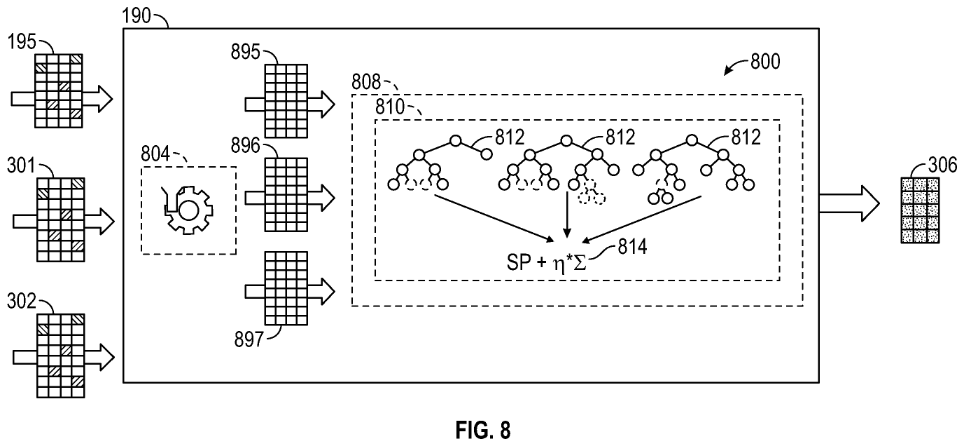

FIG. 8 depicts, generally, the flow of data through the treatment prediction system (190) using a trained gradient boosted trees regressor, in accordance with one or more embodiments. As seen, input data, for example, treatment (195), operational parameters (301), and current drilling fluid properties (302), is received by the treatment prediction system (190). In one or more embodiments, the treatment prediction system (190) includes a preprocessor (804). The preprocessor (804) may preprocess the input data according to any preprocessing methods and/or preprocessing parameters determined during training. The result of the preprocessor (804) is preprocessed data (e.g., normalized, imputed, etc.), for example, preprocessed treatment data (896), preprocessed operational parameters data (896), and preprocessed current drilling fluid property data (897).

The preprocessed data is passed to a machine-learned model (808). In FIG. 8, the machine-learned model (808) is further represented as a gradient boosted trees regressor (810) composed of a plurality of decision trees (812). As such, the preprocessed data is processed by each decision tree (812) and the output of each decision tree is collected, multiplied by the learning rate (η), summed, and added to the simple prediction (SP) established during training forming an ensemble (814). The result of the ensemble (814) is returned as the machine-learned model prediction (e.g., drilling fluid properties after treatment (306)).

As a concrete example, the workflow of FIG. 7 is applied to a set of training data to identify and deploy a high-performing machine-learned model. Each instance of training data has a treatment (195), current drilling fluid properties (302), and operational parameters (301) as an input and the drilling fluid properties after treatment (306) as the output.

Preprocessing was applied to the set of training data to correct typographical errors in the set of training data and to ensure data quality and conformity.

In this example, the set of training data is arbitrarily split into a training set and test set (Block 706). Various supervised machine-learned model types are iterated through according to Block 708 of FIG. 7. Specifically, the set of machine-learned model types consisted of linear regression, polynomial regression, random forest and neural network. A grid search is performed to discover the best combination of hyperparameters for each machine-learned model type (Block 710). For training (Block 712) and model evaluation (Block 714), a 5-fold cross-validation technique is employed such that a dedicated validation set was not required. Of the machine-learned model types evaluated, in the example presented, linear regression demonstrated the best performance and is selected (Block 716) for use in (or as) the treatment prediction system (190).

Additionally, once the model and associated hyperparameters are identified and selected, the selected machine-learned model undergoes further refinement through feature engineering. For feature engineering, only the features of the input data with high statistical significance (low p-value) are selected for the machine-learned model used in production. It is emphasized that the selected model is provided only as a working example of the treatment prediction system (190), in accordance with one or more embodiments, and does not impose nor represent a limitation on the instant disclosure.

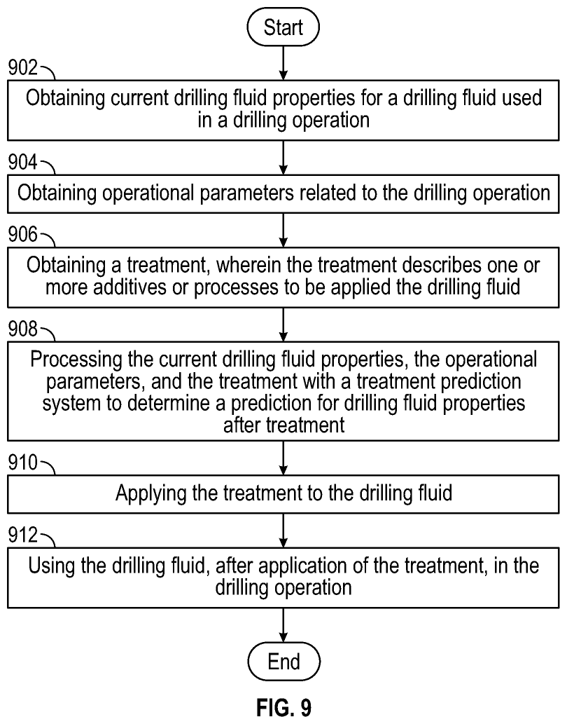

FIG. 9 depicts a flowchart outlining the use of the treatment prediction system (190) in accordance with one or more embodiments. In Block 902, the properties of a drilling fluid currently used in a drilling operation, or a drilling fluid intended to be used in a drilling operation are obtained (e.g., the initial state of a drilling fluid), where the drilling operation is conducted by a drilling system. In one or more embodiments, the current drilling fluid properties are obtained by one or more sensors disposed on an automated drilling fluid manager (110) as sensor data. The sensor data may include rheological data (e.g., rheological data A (111)), density data (e.g., density data B (112)), pH data (e.g., pH data C (113)), volume data (e.g., volume data D (114)), and flow meter data (e.g., flow meter data E (115)). The current drilling fluid properties may also be obtained through periodic sampling and testing of the drilling fluid. For example, in one or more embodiments, various standardized tests are performed on samples of the drilling fluid in order to determine one or more drilling fluid properties. In Block 904, operational parameters related to the drilling operation are obtained. The operational parameter may consist of one or more parameters that describe the drilling operation including processes involving the drilling fluid. Some operational parameters may be directly measured while others are derived from measured quantities. Operational parameters may change as drilling progresses. As such, operational parameters may be measured and/or calculated periodically. In one or more embodiments, operational parameters are determined in real time. In Block 906, a treatment is obtained, where the treatment specifies one or more additives, conditions, or processes to be applied to the drilling fluid. In one or more embodiments, a set of desired drilling fluid properties are also obtained. In Block 908, the current drilling fluid parameters, the operational parameters, and the treatment are processed with a treatment prediction system to determine a prediction for drilling fluid properties after treatment. The prediction for drilling fluid properties after treatment represents the predicted state of the drilling fluid, as predicted by the treatment prediction system, if the treatment were to be applied to the drilling fluid (with current drilling fluid properties) given the operational parameters.

In one or more embodiments, the predicted drilling fluid properties and the desired drilling fluid properties are evaluated with an inversion system to determine a treatment update. In one or more embodiments, the treatment update is applied to the treatment and the updated treatment is processed by the treatment prediction system, along with the operational parameters and current drilling fluid parameters, to determine a new prediction for the drilling fluid parameters after treatment. In one or more embodiments, one or more treatment updates are applied the treatment and the treatment is processed by the treatment prediction system until the predicted drilling fluid properties and the set of desired drilling fluid properties are sufficiently matched, where match quality may be quantified by an objective function and a checked against a user-specified threshold. In Block 910, the treatment is applied to the drilling fluid. In one or more embodiments, the treatment is only applied to the drilling fluid if the predicted drilling fluid properties after treatment sufficiently match the set of desired drilling fluid properties. In one or more embodiments, the application of the treatment to the drilling fluid is facilitated by a drilling fluid processing system. In one or more embodiments, after application of the treatment, the properties of the drilling fluid are obtained and verified against the set of desired drilling fluid properties. In Block 912, the drilling fluid, after application of the treatment, is used in the drilling operation to drill a wellbore.

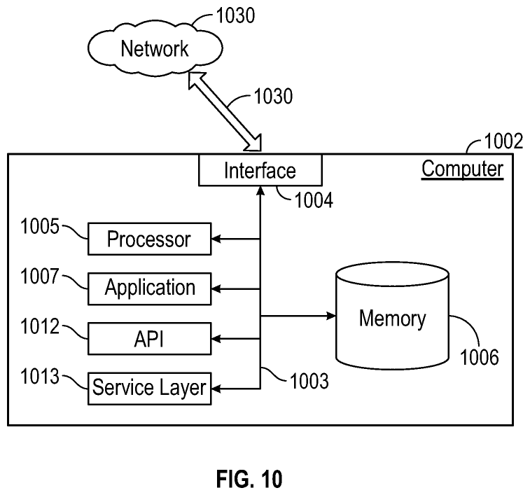

FIG. 10 further depicts a block diagram of a computer system (1002) used to provide computational functionalities associated with the algorithms, methods, functions, processes, flows, and procedures as described in this disclosure, according to one or more embodiments. The illustrated computer (1002) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1002) may include a computer that includes an input device, such as a keypad, keyboard, touch screen, or other device that can accept user information, and an output device that conveys information associated with the operation of the computer (1002), including digital data, visual, or audio information (or a combination of information), or a GUI.

The computer (1002) can serve in a role as a client, network component, a server, a database or other persistency, or any other component (or a combination of roles) of a computer system for performing the subject matter described in the instant disclosure. In some implementations, one or more components of the computer (1002) may be configured to operate within environments, including cloud-computing-based, local, global, or other environment (or a combination of environments).

At a high level, the computer (1002) is an electronic computing device operable to receive, transmit, process, store, or manage data and information associated with the described subject matter. According to some implementations, the computer (1002) may also include or be communicably coupled with an application server, e-mail server, web server, caching server, streaming data server, business intelligence (BI) server, or other server (or a combination of servers).

The computer (1002) can receive requests over network (1030) from a client application (for example, executing on another computer (1002) and responding to the received requests by processing the said requests in an appropriate software application. In addition, requests may also be sent to the computer (1002) from internal users (for example, from a command console or by other appropriate access method), external or third-parties, other automated applications, as well as any other appropriate entities, individuals, systems, or computers.

Each of the components of the computer (1002) can communicate using a system bus (1003). In some implementations, any or all of the components of the computer (1002), both hardware or software (or a combination of hardware and software), may interface with each other or the interface (1004) (or a combination of both) over the system bus (1003) using an application programming interface (API) (1012) or a service layer (1013) (or a combination of the API (1012) and service layer (1013). The API (1012) may include specifications for routines, data structures, and object classes. The API (1012) may be either computer-language independent or dependent and refer to a complete interface, a single function, or even a set of APIs. The service layer (1013) provides software services to the computer (1002) or other components (whether or not illustrated) that are communicably coupled to the computer (1002). The functionality of the computer (1002) may be accessible for all service consumers using this service layer. Software services, such as those provided by the service layer (1013), provide reusable, defined business functionalities through a defined interface. For example, the interface may be software written in JAVA, C++, or other suitable language providing data in extensible markup language (XML) format or another suitable format. While illustrated as an integrated component of the computer (1002), alternative implementations may illustrate the API (1012) or the service layer (1013) as stand-alone components in relation to other components of the computer (1002) or other components (whether or not illustrated) that are communicably coupled to the computer (1002). Moreover, any or all parts of the API (1012) or the service layer (1013) may be implemented as child or sub-modules of another software module, enterprise application, or hardware module without departing from the scope of this disclosure.

The computer (1002) includes an interface (1004). Although illustrated as a single interface (1004) in FIG. 10, two or more interfaces (1004) may be used according to particular needs, desires, or particular implementations of the computer (1002). The interface (1004) is used by the computer (1002) for communicating with other systems in a distributed environment that are connected to the network (1030). Generally, the interface (1004) includes logic encoded in software or hardware (or a combination of software and hardware) and operable to communicate with the network (1030). More specifically, the interface (1004) may include software supporting one or more communication protocols associated with communications such that the network (1030) or interface's hardware is operable to communicate physical signals within and outside of the illustrated computer (1002).

The computer (1002) includes at least one computer processor (1005). Although illustrated as a single computer processor (1005) in FIG. 10, two or more processors may be used according to particular needs, desires, or particular implementations of the computer (1002). Generally, the computer processor (1005) executes instructions and manipulates data to perform the operations of the computer (1002) and any algorithms, methods, functions, processes, flows, and procedures as described in the instant disclosure.

The computer (1002) also includes a memory (1006) that holds data for the computer (1002) or other components (or a combination of both) that can be connected to the network (1030). The memory may be a non-transitory computer readable medium. For example, memory (1006) can be a database storing data consistent with this disclosure. Although illustrated as a single memory (1006) in FIG. 10, two or more memories may be used according to particular needs, desires, or particular implementations of the computer (1002) and the described functionality. While memory (1006) is illustrated as an integral component of the computer (1002), in alternative implementations, memory (1006) can be external to the computer (1002).

The application (1007) is an algorithmic software engine providing functionality according to particular needs, desires, or particular implementations of the computer (1002), particularly with respect to functionality described in this disclosure. For example, application (1007) can serve as one or more components, modules, applications, etc. Further, although illustrated as a single application (1007), the application (1007) may be implemented as multiple applications (1007) on the computer (1002). In addition, although illustrated as integral to the computer (1002), in alternative implementations, the application (1007) can be external to the computer (1002).

There may be any number of computers (1002) associated with, or external to, a computer system containing computer (1002), wherein each computer (1002) communicates over network (1030). Further, the term “client,” “user,” and other appropriate terminology may be used interchangeably as appropriate without departing from the scope of this disclosure. Moreover, this disclosure contemplates that many users may use one computer (1002), or that one user may use multiple computers (1002).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining current drilling fluid properties for a drilling fluid used in a drilling operation;
obtaining operational parameters related to the drilling operation;
obtaining a treatment, wherein the treatment describes one or more additives or processes to be applied the drilling fluid;
processing the current drilling fluid properties, the operational parameters, and the treatment with a treatment prediction system to determine a prediction for drilling fluid properties after treatment;
applying the treatment to the drilling fluid; and
using the drilling fluid, after application of the treatment, in the drilling operation.

2. The method of claim 1, further comprising:
receiving a set of desired drilling fluid properties; and
verifying that properties of the drilling fluid after application of the treatment match the set of desired drilling fluid properties.

3. The method of claim 1, wherein the treatment prediction system preprocesses the current drilling parameters, the operational parameters, and the treatment.

4. The method of claim 1, wherein the treatment prediction system comprises a machine-learned model.

5. The method of claim 4, wherein the machine-learned model is a gradient boosting regressor.

6. The method of claim 4, further comprising:
selecting a machine-learned model type and hyperparameters;
training the machine-learned model;
evaluating the trained machine-learned model;
adjusting the machine-learned model hyperparameters; and
re-training the trained machine learned model with the adjusted machine-learned model hyperparameters.

7. The method of claim 2, further comprising processing the prediction for drilling fluid properties after treatment and the set of desired drilling fluid properties with an inversion system to determine a treatment update.

8. A non-transitory computer-readable memory comprising computer-executable instructions stored thereon that, when executed on a processor, cause the processor to perform steps comprising:
obtaining current drilling fluid properties for a drilling fluid used in a drilling operation;
obtaining operational parameters related to the drilling operation;
obtaining a treatment, wherein the treatment describes one or more additives or processes to be applied the drilling fluid; and
processing the current drilling fluid properties, the operational parameters, and the treatment with a treatment prediction system to determine a prediction for drilling fluid properties after treatment;
wherein, upon application of the treatment to the drilling fluid, the drilling fluid is used in the drilling operation.

9. The non-transitory computer-readable memory of claim 8, wherein the instructions further comprise functionality for:
receiving a set of desired drilling fluid properties; and
verifying that properties of the drilling fluid after application of the treatment match the set of desired drilling fluid properties.

10. The non-transitory computer-readable memory of claim 8, wherein the treatment prediction system preprocesses the current drilling parameters, the operational parameters, and the treatment.

11. The non-transitory computer-readable memory of claim 8, wherein the treatment prediction system comprises a machine-learned model.

12. The non-transitory computer-readable memory of claim 11, wherein the machine-learned model is a gradient boosting regressor.

13. The non-transitory computer-readable memory of claim 11, wherein the instructions further comprise functionality for:
selecting a machine-learned model type and hyperparameters;
training the machine-learned model;
evaluating the trained machine-learned model;
adjusting the machine-learned model hyperparameters; and
re-training the trained machine learned model with the adjusted machine-learned model hyperparameters.

14. The non-transitory computer-readable memory of claim 9, wherein the instructions further comprise functionality for processing the prediction for drilling fluid properties after treatment and the set of desired drilling fluid properties with an inversion system to determine a treatment update.

15. A system, comprising:
a drilling system conducting a drilling operation, the drilling system comprising a drilling fluid, wherein the drilling system is configured to drill a wellbore through a subsurface; and
a computer configured to:
obtain current drilling fluid properties for the drilling fluid used in the drilling system;
obtain operational parameters related to the drilling operation;
obtain a treatment, wherein the treatment describes one or more additives or processes to be applied the drilling fluid; and
process the current drilling fluid properties, the operational parameters, and the treatment with a treatment prediction system to determine a prediction for drilling fluid properties after treatment;
wherein, upon application of the treatment to the drilling fluid, the drilling fluid is used in the drilling operation.

16. The system of claim 15, wherein the computer is further configured to:
receive a set of desired drilling fluid properties; and
verify that properties of the drilling fluid after application of the treatment match the set of desired drilling fluid properties.

17. The system of claim 15, wherein the treatment prediction system preprocesses the current drilling parameters, the operational parameters, and the treatment.

18. The system of claim 15, wherein the treatment prediction system comprises a machine-learned model.

19. The system of claim 18, wherein the machine-learned model is a gradient boosted regressor.

20. The system of claim 16, wherein the computer is further configured to process the prediction for drilling fluid properties after treatment and the set of desired drilling fluid properties with an inversion system to determine a treatment update.
